(19) United States
(12) Patent Application Publication
(10) Pub. No.: US 2017/0302876 A1
(43) Pub. Date: Oct. 19, 2017

(54) SYSTEM AND METHOD OF CONTROLLING AND ENFORCING SCREEN USAGE

(71) Applicant: LimitScreen Inc., Scarsdale, NY (US)

(72) Inventors: Tali Orad, Scarsdale, NY (US); Amir Orad, Scarsdale, NY (US); Gonen Bronshtein, Tel Aviv (IL); Yaniv Dayan, Tel Aviv (IL); Amir Zilberstein, Scarsdale, NY (US)

(21) Appl. No.: 15/466,414

(22) Filed: Mar. 22, 2017

Related U.S. Application Data
(60) Provisional application No. 62/391,014, filed on Apr. 15, 2016.

(51) Int. Cl. H04N 5/44; H04W 68/00; H04N 5/38; H04W 12/06; H04L 29/12

(52) U.S. Cl. CPC H04N 5/4403; H04N 5/38; H04W 12/06; H04W 68/00; H04L 61/6068; H04N 2005/4442

(57) ABSTRACT

A system, method, and computer product, the system comprising: a transmitter configured to transmit a multiplicity of commands related to managing usage of a screen in accordance with one or more rules, the multiplicity of commands sent at intervals during an applicability time period of a rule; and a receiver operatively connected to the screen, the receiver configured to receive the commands from the transmitter and apply the commands to the screen, thereby managing usage of the screen for the applicability time period of the rule, wherein the transmitter and the receiver communicate with each other using authenticated communication.

### TECHNICAL FIELD

The present disclosure relates to screen usage in general, and to a system and method for controlling and enforcing usage of screens in particular.

### BACKGROUND

Many people in the developed or developing countries, including children, spend long hours every day in front of computerized displays, including mobile phones, computers, tablets, streaming devices, television sets, game consoles, starlight or cables, projectors, or others.

Although watching such displays may have positive impacts, most researchers agree that the amount of time people, and in particular children spend in front of displays should be limited, to allow time for family time, homework, social activity, book reading, free play, sports and other activities.

However, exercising parental limitations, including making a child stop watching TV or another screen for other activities, eating their meals with the family, or going to sleep is not an easy task. This is particularly true when the guardian, such as a parent of a child is not always present at home.

Furthermore, a lot of content is available for watching on any medium which is not suitable for children, and should be prevented. Thus, even during times when it is allowed to watch TV, a parent may want to control the content or content type a child is allowed to consume specific channels or source, or the like.

In some entities, such as hospitals, schools, shopping centers or others, management may wish to exercise similar control in the respective institution. For example, they may want to limit the content or channels, or interrupt the current flow of displayed content and inject a management relevant content, including for example commercials, in the right time and place to a television monitor in a waiting room, or even prevent customers from simply switching to a different channel.

### BRIEF SUMMARY

One exemplary embodiment of the disclosed subject matter is a system for managing usage over a screen comprising: a transmitter configured to transmit a multiplicity of commands related to managing usage of a screen in accordance with one or more rules, the multiplicity of commands sent at intervals during an applicability time period of a rule; and a receiver operatively connected to the screen, the receiver configured to receive the commands from the transmitter and apply the commands to the screen, thereby managing usage of the screen for the applicability time period of the rule, wherein the transmitter and the receiver communicate with each other using authenticated communication. Within the system, the transmitter optionally comprises: a user interface for receiving a description of the rules from a supervisor; a command generator for generating the multiplicity of commands upon the rules; a command enforcer for determining a command from the multiplicity of commands to be transmitted to the receiver; and a communication module for transmitting the command to the receiver. Within the system, the receiver optionally comprises: a communication module for receiving a command from the receiver; and a command application module for applying the command to the screen, thereby limiting operation of the screen in accordance with the at least one rule. The system can further comprise: a global management module for receiving a description of the rules; and a rule storage accessible via the Internet, wherein the transmitter further comprises a rule or command communicator for receiving rules or commands from the rule storage, and wherein a description via the global management module is stored on the rule storage and is provided to the transmitter. The system can further comprise one or more second transmitters. Within the system, the transmitter optionally comprises a tamper proof module for identifying tamper or tamper attempt to the transmitter, and the transmitter is optionally configured to notify a supervisor about the tamper or tamper attempts. Within the system, the tamper proof module optionally comprises a battery and/or a motion sensor and/or an electricity disconnect detection component. Within the system, one or more of the rules optionally relates to turning the screen off at predetermined time, turning the screen on at predetermined time, blocking the screen, and showing information on the screen. Within the system, one or more of the rules optionally relates to limiting content displayed on the screen. The system can further comprise one or more second receivers, wherein the transmitter is also configured to transmit a second multiplicity of commands to the second receiver. Within the system, the receiver optionally transmits to the transmitter notifications related to usage of the screen or to compliance of the user with the rules.

Another exemplary embodiment of the disclosed subject matter is method of controlling usage over a screen, comprising: transmitting a multiplicity of commands related to limiting usage of a screen in accordance with one or more rules, the multiplicity of commands sent by a transmitter to a receiver operatively connected to the screen at time intervals during an applicability time period of a rule, wherein the receiver is configured to apply the commands to the screen, wherein the transmitter and the receiver communicate in an authenticated manner. The method can further comprise: receiving a description of the rules from a supervisor; generating the multiplicity of commands upon the rules; and determining a command from the multiplicity of commands to be transmitted to the receiver. The method can further comprise: storing the rules or the multiplicity of commands in a rule storage accessible via the Internet, and transmitting the rule or the multiplicity of commands to the transmitter. Within the method, one or more of the rules can relate to turning the screen off at predetermined time, turning the screen on at predetermined time, blocking the screen, and showing information on the screen or to limiting content displayed on the screen. The method can further comprise receiving a notification related to tampering or tampering attempt of the transmitter.

Yet another exemplary embodiment of the disclosed subject matter is system for controlling usage over a screen comprising: a transmitter configured to transmit a multiplicity of commands related to limiting usage of a screen in accordance with one or more rules, the multiplicity of commands sent at intervals during an applicability time period of a rule, the transmitter comprising a tamper proof module for identifying tampering or tampering attempts to the transmitter, the tamper proof module comprising a battery; and a receiver operatively connected to the screen, the receiver configured to receive the commands from the transmitter and apply the commands to the screen, thereby limiting usage of the screen for the applicability time period of the rule, wherein the wherein the transmitter and the receiver communicate in an authenticated manner.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a generalized diagram of a first exemplary configuration of a system for controlling screen usage, in accordance with some exemplary embodiments of the disclosure;

FIG. 1B shows an exemplary display of a dialog with which a supervisor can define a rule, in accordance with some exemplary embodiments of the disclosure;

FIG. 1C shows an exemplary display of another dialog with which a supervisor can define another rule, in accordance with some exemplary embodiments of the disclosure;

FIG. 2 shows a generalized diagram of a second exemplary configuration of a system for controlling screen usage, in accordance with some exemplary embodiments of the disclosure;

FIG. 3 shows a generalized diagram of a third exemplary configuration of a system for controlling screen usage, in accordance with some exemplary embodiments of the disclosure;

FIG. 4 shows a generalized diagram of a tamper proof module, in accordance with some exemplary embodiments of the disclosure;

FIG. 5 shows a flowchart of an exemplary method of controlling screen usage, in accordance with some exemplary embodiments of the disclosure;

FIG. 6 shows a schematic screen shot of a user interface of a management device used by a supervisor when shutting down one or more screens, in accordance with some exemplary embodiments of the disclosed subject matter;

FIG. 7 shows a schematic screen shot of a TV during shutdown due to supervisor enforcement, in accordance with some exemplary embodiments of the disclosed subject matter; and

FIG. 8 shows a schematic screen shot of a TV being blocked due to the enforcement of a rule, in accordance with some exemplary embodiments of the disclosed subject matter.

### DETAILED DESCRIPTION

The term “screen” as used herein should be expansively construed to include any computerized display displaying content, such as a TV monitor; a display monitor; a projector; a display of a mobile device, a desktop monitor, a handheld device, game system, or the like.

The term “user” as used herein should be expansively construed to include any person watching or being exposed to a screen, e.g., a child, an employee, a student, a member of public in private, public, or commercial premises, or the like.

The term “supervisor” as used herein should be expansively construed to include any person in charge of a user or responsible to a screen a user can watch, such as a parent, a teacher, a manager, a caregiver, a site supervisor, a clinic manager, a shopping center manager, a hospital or department staff member, a school principal, or the like.

One technical problem handled by the disclosed subject matter is the need to exercise parental control over the usage of screens that display content, such as a computer screen, a TV set, a handheld device, or the like. In some examples, the control should include days or times at which watching is limited or prohibited, limitation on the displayed content or content source, such as TV channels or content from specific sites allowed. Some limitations may include a combination of content and time, for example some content may be allowed only on certain days or times.

Similar control may have to be exercised by a supervisor in public or private premises, for example a person in charge of a television in a shopping center, a waiting room, or a multiplicity of such TVs, wherein each may be required, allowed or forbidden to display certain content, and wherein the users are not allowed to control whether or which content is displayed on the screen.

One technical solution comprises a transmitter (herein referred to as Tx) device, responsible for transmitting content to be displayed on a screen, or commands related to activation of the screen in accordance with one or more rules set by a supervisor to a receiver that controls the screen. For example, a supervisor can set a rule that blocks the screen in a specific time frame, such that will not be able to watch any other content throughout the timeframe. In another example, a supervisor can set a rule that will enforce displaying of allowed content, e.g., commercials to be displayed on a public screens, educational materials in a class or at home.

Thus, the commands sent by the transmitter may relate to whether the screen is to be blocked or powered off, a message to be displayed on the screen, which content is allowed or forbidden to be displayed or from which source, limitation on usage time of the screen, or the like. In some embodiments, the Tx may comprise, execute, or receive rules from a management module, the rules arranged for example as a rule schedule. The rules may be entered by a supervisor, imported from a computerized source, or otherwise obtained, as detailed below. The Tx may then generate commands in accordance with the rules. Additionally or alternatively, the Tx may receive commands from an external device, the commands generated upon rules entered by a supervisor.

The Tx can be any device, such as a desktop computer, a laptop computer, a mobile phone, a dedicated device, or the like.

The controlled screen can be equipped with a receiving component (herein referred to as Rx) responsible for receiving commands or content from a Tx, and controlling the screen accordingly. In some exemplary embodiments, the Rx can be a hardware streaming device external to the screen and operatively connected to the screen, such as Chromecast available from Google of Mountain View, Calif., USA, Amazon Fire TV available from Amazon of Seattle Wash., USA, Roku available from Roku of Saratoga, Calif., USA, Apple TV available from Apple of Cupertino, Calif., USA, or the like.

In other exemplary embodiments, the Rx can be implemented as a part of the screen. In some exemplary embodiments the Rx can be implemented as a software module internal to the screen, and controlling the screen operation. Moreover, the Rx can be an application which is automatically or manually downloaded and installed on the screen. In other embodiments, the Rx can be a hardware component that is part of the monitor, such as android TV, or a screen which supports cast protocols such as Google Cast protocol or DIAL protocol, a TV with an appropriate protocol for screen mirroring features, or the like. In further implementations, the Tx can be implemented within the screen as well.

The Tx may comprise a communication module for transmitting commands or content to an Rx. In some embodiments, the communication can be two-way such that the Rx also transmits information to the Tx. In some embodiments the Tx may be collocated with the screen, or within a small distance from the screen as detailed below. In some embodiments, the Tx can be on the same network as the Rx, such as a home network, in order to avoid displaying content in accordance with commands transmitted by a device used by a person outside the local network. Thus, the Tx and the Rx are located or associated so that they can engage in communication, or are otherwise associated such that authenticated communication between Tx and Rx is provided. For example: the Rx will have a certificate from authorized entity like in SSL communication and Tx will try to establish secure connection between it and the Rx during which it will read the Rx certificate and decide whether to connect to this device. In some embodiments, a Tx can control a multiplicity of Rx devices, thus controlling usage of a multiplicity of screens.

The Tx can transmit commands when a rule applicable to the day and time, or other parameters takes effect, for example when it is time to turn the screen on or off, block the screen or enable the screen to display content, or when another limitation is to take effect. The Tx may also transmit commands periodically afterwards as long as a rule is in effect, for example every 0.1 second to every 5 seconds, in order to prevent a user from attempting to override the rule, thus providing a “watchdog” operation that keeps enforcing the rule. The user may therefore succeed in overriding the rule, for example turning the screen back on, switching to a forbidden channel, or the like, but only for a short and unrewarding period of time, and upon the next command being received by the Rx the rule will take effect again. The Tx may also transmit commands prior to a rule taking effect, for example for displaying reminders.

In some exemplary embodiments, the Tx may be controlled by a remote device, for example through a cloud server, and physical access to the Tx may not be required for defining the rules. In these embodiments, a supervisor can set or change the rules using a remote device communicating with the Tx. The Tx transmits the corresponding commands to the Rx which controls the screen, as long as the Tx is within the local network of the screen. In such embodiments, not only a supervisor having physical access to the Tx, but rather a multiplicity of supervisors may change or set the rules. For example, when parental control is required, each caregiver can set or change the rules remotely, and not only a parent who is at home. Moreover, a supervisor present at the location may also change the rules using remote access rather than physical access to the Tx. It will be appreciated, however, that only authorized supervisors can change the rules for a particular screen. Authorization may be determined upon changing the rules using a device from within the network of the Rx, or upon any other authentication mechanism.

In such embodiments in which the Tx is in communication with a remote device, the Tx can also receive content from the remote device, such as text messages, images, audio, video content, or the like, to be displayed on the screen. In such embodiments, the remote device may provide rules or commands to a multiplicity of Tx, each controlling one or more screens. This embodiment may be useful for multi-screen environment, such as a shopping center, a hospital, a school, or the like, wherein each screen may have to display different content or otherwise comply with different rules.

One technical effect of the disclosure provides an overall solution allowing the management of a multiplicity of screens in one or more geographic locations. Management can include.

Another technical effect of the disclosure provides for managing multiple sites, each possible containing multiple screens at any time or location. The disclosure enables a management to categorize the locations and screens by properties such as the field of interest and display relevant content per category.

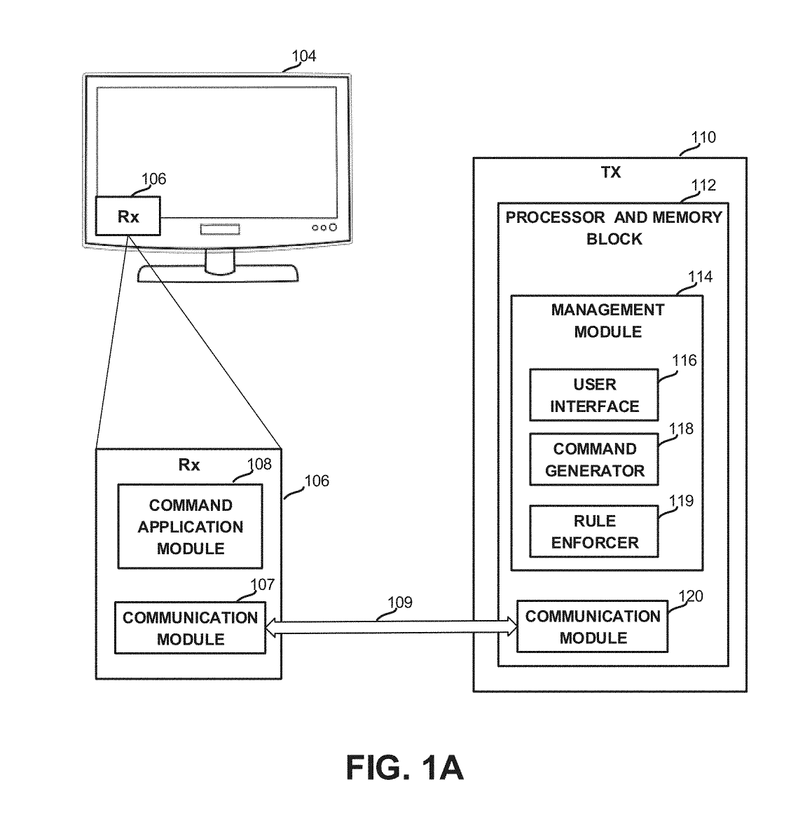

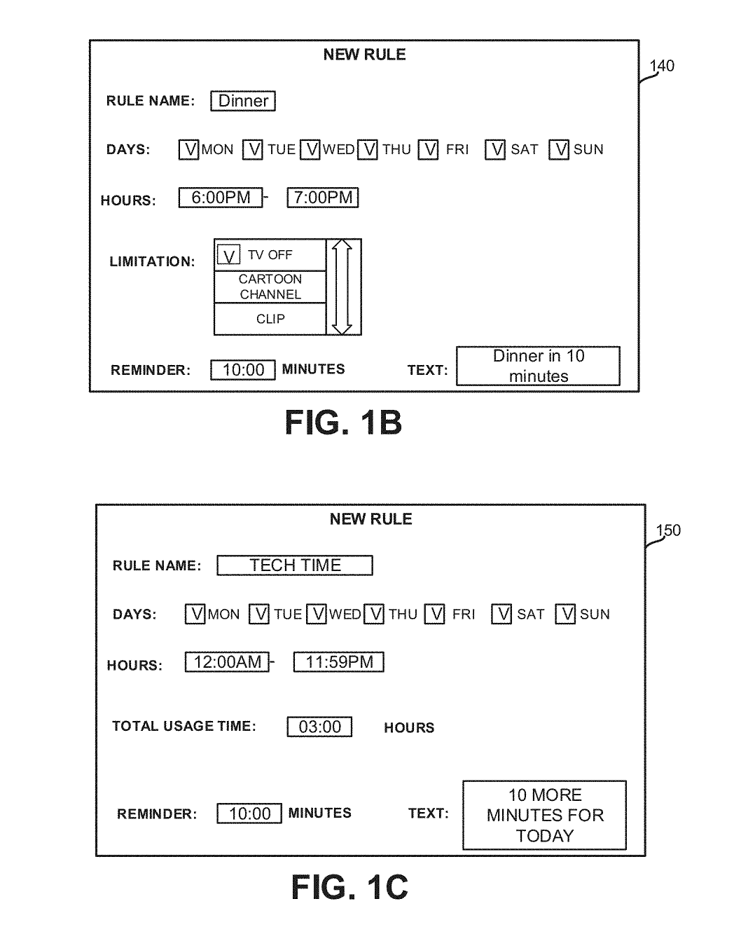

Referring now to FIG. 1A, showing a generalized diagram of a first configuration of a system for controlling screen usage, in accordance with the disclosure.

The system operates with a screen 104, and comprises a receiver Rx 106. Rx 106 can be implemented as a hardware component as detailed above, or as a software component operative to perform activation of various functions of screen 104, such as shutting down, restarting, changing channel, displaying content provided over a communication channel, or the like.

Rx 106 can comprise a communication module 107 for communicating with Tx 110, for example receiving commands from Tx 110 and optionally transmitting notifications or content to Tx 110. Communication module 107 can be operative in decrypting or decoding the received commands as required. communication module 107 can communicate with Tx 110 and in particular with communication module 120 within Tx 110 over communication channel 109. Communication channel 109 can be a network, such as a home network, or another local area network (LAN), or wireless LAN.

Rx 106 can comprise a command application module 108 for applying a command and thus operating screen 104 in accordance with the rule upon which the command was generated. Applying the command may include sending notifications or content to the Tx, as detailed below.

Tx 110 can be any device within the network of Rx 106, such as a mobile phone, a desktop computer, a tablet computer, a beam-forming device, or the like. In particular, Tx 110 can be a mobile phone of a supervisor, which provides for enforcing the rules when the supervisor, or at least his or her mobile phone, is within the network of Rx 106. Tx 110 can also be in a form of an application, software, hardware, or any combination thereof.

Tx 110 can comprise a processor and memory block (PMB) 112 operatively connected to a hardware-based input or output device, such as a display device, a touch screen, a voice activated interface, or the like. PMB 112 is configured to provide all processing necessary for operating Tx 110. PMB 112 comprises a processor (not shown separately) and a memory (not shown separately). The processor of PMB 112 can be configured to execute several functional modules in accordance with computer-readable instructions implemented on a non-transitory computer-readable memory comprised in PMB 112. Such functional modules are referred to hereinafter as comprised in PMB 112.

PMB 112 can also store and retrieve one or more rules to be applied.

PMB 112 can comprise a management module 114 for defining rules, generating commands upon the rules and enforcing them.

Thus, management module 114 can comprise user interface 116 for a supervisor to define one or more rules, such as shown in association with FIG. 1B and FIG. 1C below. User interface 116 can be operative in storing the rules on a storage device. In further embodiments, user interface 116 can make some checks, for example verifying that no contradiction exists between rules, or making sure that if a contradiction exists, then the user indicates which rule is to take effect, or the like. For example, user interface 116 can display a warning message in case of contradiction, or can disable the supervisor from entering such contradicting rules.

In some embodiments, a rule can be defined using free text entered into a text field presented to the supervisor. Using text analysis methods, a set of rules may be derived from the text. For example, the text “Dinner time is between 6PM and 7PM every day, at this time, the living room TV is off.

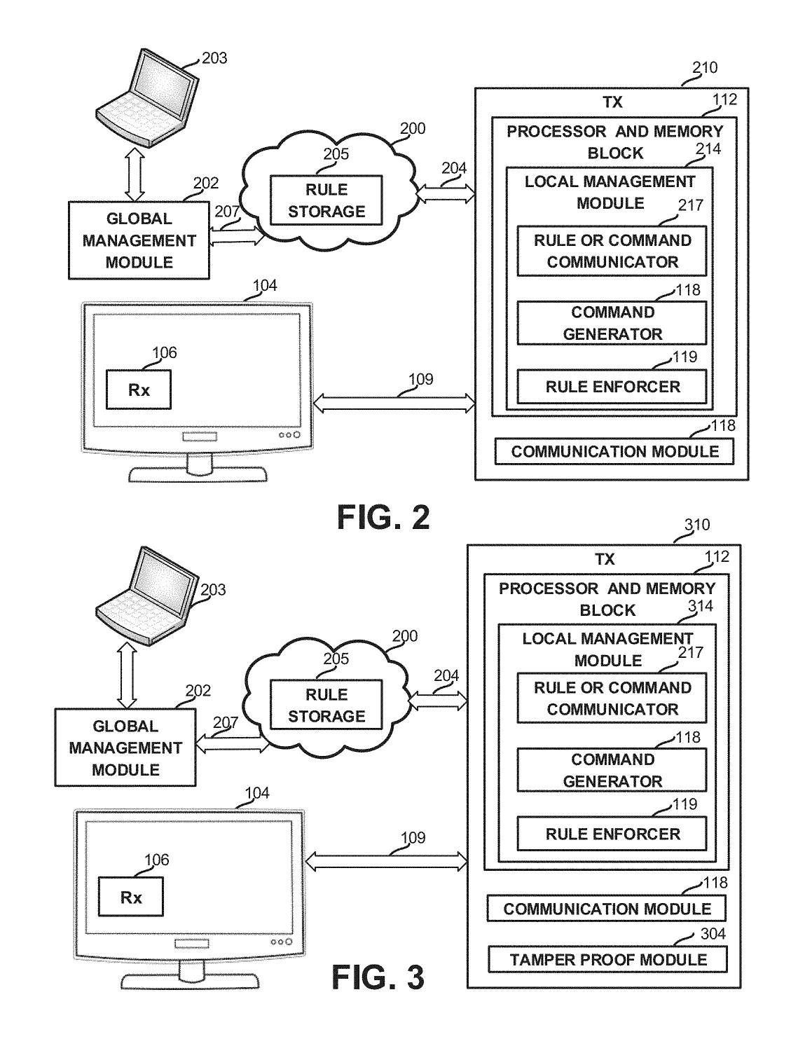

Reminder is 10 minutes” may be interpreted to the rule shown in FIG. 2 below. In some embodiments, a dialog such as the dialogs of FIGS. 1B and 1C may be displayed to a supervisor, and the supervisor can continue editing the rule using the dialog or via the text field. Optionally, some initial settings may be required before text can be entered, such as selecting one or more controlled screens, or the like.

Management module 114 can further comprise command generator 118, for generating commands based on the applicable rules. For example, command generator 118 can generate commands to be transmitted when a reminder is to be displayed prior to enforcing a rule, when a rule is in effect, or the like. The commands can be generated in advance, for example when the rule is received from user interface 116. The commands may be stored, and then retrieved prior to transmission. Alternatively, the commands may be generated on-line prior to the rule taking effect.

Management module 114 can further comprise rule enforcer 119 for determining one or more commands to be transmitted to Rx 106 at the relevant day, time, or other parameters in order to enforce the applicable rules. For example, rule enforcer 119 may determine the transmission of a command at the beginning of the applicability period of a rule, and at time intervals during the period, until the end of the applicable time period, such that a user cannot override the rule for substantial periods of time. The time intervals can be, in a non-limiting example, between 0.1 second and 1 minute. In some embodiments, in accordance with the defined rule, a reminder command may be transmitted prior to the enforcement of a rule, at the time defined for the reminder. Rule enforcer 119 can provide the commands to communication module 120, which transits the commands to Rx 106.

PMB 112 can further comprise communication module 120 for communicating with Rx 106 over communication channel 109, transmitting the commands to Rx 106, and optionally receiving indications from Rx 106. Communication module 120 of Tx 110 and Communication module 107 of Rx 106 can communicate in any applicable protocol, such as but not limited to the Discover and Launch (“DIAL)” protocol. Communication module 120 can encode or encrypt the commands prior to transmission.

In some embodiments, Tx 110 can transmit content to Rx 106, to be displayed on screen 104, and one or more rules can allow Rx 106 to display content received from Tx 110, such as a video clip stored on a memory device of Tx 110. The transmission can include the content itself, for example in the form of coded video to be decoded and displayed. In other embodiments, Tx 110 can activate remote procedures on Rx 106, such that instead of transmitting the actual video, Rx 106 can transmit a command, for example to display a clip from a particular URL.

In some embodiments, Rx 106 can transmit notifications to Tx 110, which may relate to actions of the user associated with the rules, such as whether and at what time the user turned the screen on or off, attempted to switch to a forbidden channel, or the like. Tx 106 can utilize user interface 116 to present the notifications, or some processing thereof, to the supervisor.

Thus, the configuration shown in FIG. 1A allows a supervisor to monitor, limit, supervise, enforce or control the screen usage time and duration, or the content being displayed to a user at any given time. This configuration may require that Tx 110 and Rx 106 are configured to communicate over a secure channel, such as the same network, implying that Tx 110 is physically located nearby Rx 106, for example within a maximal distance to establish successful engagement between Tx 110 and Rx 106, or that Tx 110 and Rx 106 communicate with authenticated communication. It will be appreciated that if Tx 110 is outside the maximal range, although applicable rules may be defined and commands are transmitted, the rules may not take effect since transmission will not reach Rx 106. This configuration requires network connection, however active Internet connection is not necessary.

In some embodiments, Tx 110 may control a multiplicity of Rx 106, for example multiple screens in a house, in a shopping center, in a hospital, or the like, may be operated under the same or different rules. Tx 110 can thus transmit commands to a multiplicity of Rx 106, for example in a repeated predetermined order. However, the maximal number of Rx 106 serviced by one Tx 110 may be predetermined.

In a system in accordance with the configuration of FIG. 1A, Tx 110 can control the screen, as well as external devices connected to the screen, such as game consoles, video streamers, or the like.

It will be appreciated that excluding the case in which Rx 106 is implemented as a hardware device, the division between the components of Tx 110 and Rx 106 can be different. For example, Tx 110 or parts thereof can also be implemented as part of the screen or as a device attached to the screen. In another example, the screen may be controlled by a device external to the screen, which can thus be implemented as part of Tx 110.

Referring now to FIG. 1B, showing an exemplary display of a dialog 140 in which a supervisor can define a rule. The dialog enables the supervisor to assign a name for the rule, for example “Dinner”, select the days and times for which the rule is applicable, the limitation applied by the rule, for example whether the screen is to be turned on, turned off, enabled or blocked, content from specific channels may be enabled or disabled, content type may be enabled or disabled, or the like. The dialog can further enable a supervisor to define a reminder for the rule, and text to be displayed as a reminder or when the rule is in effect.

Referring now to FIG. 1C, showing an exemplary display of another dialog 150 in which a supervisor can define another rule, related to the total amount of time the user is allowed to watch TV or use another screen. The dialog enables the supervisor to assign a name for the rule, for example “Tech Time”, and select the days and times for which the rule is applicable. The rule indicates a total usage time within the indicated hour range on each day on which the rule is applicable, for example 3 hours. The dialog can further enable a supervisor to define a reminder for the rule to be displayed before the rule takes effect, and text to be displayed as a reminder or when the rule is in effect.

It will be appreciated that the dialog presented in FIG. 1B is exemplary only, and that any other arrangement for defining the applicable rules, including additional or different details may be designed. Other exemplary dialogs can show the definition of a rule limiting the usage time of a screen per day or during a certain time frame, a rule for filtering or flagging content, or the like. In some embodiments, as detailed below, a supervisor may receive one or more screen captures, or a continuous transmission of the screen. Such usage can also be defined as rule to be enforced on the screen. It will also be appreciated that the dialog can comprise a free text field, wherein the free text may then be parsed to derive one or more rules.

Referring now to FIG. 2, showing a generalized diagram of a second configuration of a system for controlling screen usage, in accordance with the disclosure.

The configuration of FIG. 2 comprises Rx 106 controlling screen 104, wherein Rx 106 can be external or internal to screen 104. The configuration further comprises Tx 210, which may be required to be in the vicinity of Rx 106, such that they reside on the same network or can communicate in an authenticated manner Tx 210 can be any device with internet communication capabilities, for example an unused mobile device, a tablet, a laptop computer, a desktop computer, or the like.

Tx 210 can comprise a local management module 214 similar to management tool 114 of FIG. 1. Local management module 214 can comprise command generator 118 and rule enforcer 119 as in FIG. 1. However, local management module 214 can comprise rule or command communicator 217 for retrieving rules or commands from a remote location, such as rule storage 205 of cloud server 200. In some embodiments, command generator 118 can be omitted, if Tx 210 receives from cloud server 200 the commands to be transmitted to Rx 106 rather than the rules.

In the configuration of FIG. 2, there may be provided a global management module 202, which may be implemented as an application, such as a web application, a mobile application, or web portal accessible via a corresponding interface. The rule set can be entered or edited by a supervisor having compatible privileges and using any computing platform 203 external to the network of Rx 106 to access a user interface component of global management module 202. The supervisor may access global management module 202 through a web browser, a mobile application interface, or the like. Global management module 202 can communicate with rule storage 205 on cloud server 200 via wired or wireless communication channel 207, and may store the entered or edited rules on rule storage 205. Tx 210 can communicate via wired or wireless communication channel 204 with rule storage 205 for retrieving rules. Thus, a supervisor present in the vicinity of Tx 210 can still edit the rules by accessing global management module 202 form any commuting platform, including but not limited to Tx 210 or any other computing platform. Global management module 202 can then store the rules on rule storage 205, from which the rules may be downloaded to Tx 210.

Every predetermined period of time, or prior to activation of a rule, Tx 210 can pole rule storage 205 to download the latest version of the applicable rule set to be activated, in case a remote supervisor edited the rules the rule has been downloaded.

It will be appreciated that rule storage 205 can store additional data, such as revision history, user and supervisor profile, content to be displayed, commands derived from the rule, or the like.

This configuration enables multiple supervisors, such as two or more caregivers to edit the rules whether any of them is in the vicinity of screen 104 or not. As Tx 110 of Fig.1, Tx 210 can control a multiplicity of Rx 106, wherein one or more supervisors can change the rules applicable to any Rx 106.

Furthermore, this configuration enables Tx 210 to receive content from the Internet and transmit the content to Rx 106 to be displayed on screen 104.

This configuration thus allows multiple supervisors to monitor, limit, supervise, review, enforce and control screen usage time and content that is being consumed by users at any given time, and from any location as long as Tx 210 is physically located within the network of Rx 106, for example in a distance that allows for establishing successful engagement between Tx 210 and Rx 106. With this configuration, too, Tx 214 can be a computing device such as an unused mobile device not being regularly used, a computer, a tablet, a beam-forming device, or the like, having access to cloud server 200. Tx 214 can communicate with a multiplicity of Rx 106 units, and thus control multiple screens.

Global management module 202 can communicate with a multiplicity of Tx 210 devices, and can allocate to every Rx 106 a Tx 210 in its network. Global management tool 204 can then verify successful engagement between each Tx 210 and Rx 106 pair. The rules edited by any supervisor in accordance with a required schedule can then be applied automatically as long as the relevant Tx 210 is in the same network as Rx 106. This configuration requires an active Internet connection to allow communication between the Tx 210 and cloud server 200, for poling the latest rules, wherein the communication is authenticated.

Controlling or managing a multiplicity of transmitters can also be used for categorizing the transmitters and allowing different rules or content for each category, in accordance with needs, interests, or the like.

Referring now to FIG. 3, showing a generalized diagram of yet another configuration of a system for controlling screen usage, in accordance with the disclosure.

The configuration shown in FIG. 3 is similar to the configuration shown in Fig.2. Thus, the configuration of FIG. 3 comprises Rx 106 controlling screen 104; global management module 202 accessed by computing platform 203 external to the network of Rx 106; and cloud server 200 storing rule storage 205.

Tx 310, however, may be a dedicated device, comprising additional capabilities over those of a generic computing platform which can be used as Tx 210. As in Tx 210 of FIG. 2, Tx 310 comprises PMB 112, and management module 314 comprising rule communicator 217, command generator 118 and rule enforcer 119. Since Tx 310 is a dedicated device, it may be connected to the electricity network, to avoid the need for battery replacement or recharging.

The additional capabilities of Tx 310 over Tx 210 can include but are not limited to any one or more of the following: wider communication range, a multiplicity of channel frequencies that allows Tx 310 to control several Rx 106 simultaneously, constant power input such that Tx 310 does not need to be charged, data storage capabilities, automatic synchronization feature, no dependency on phone operator server or signal, longer life span, light and sound indications, data process capabilities, log recording, or the like.

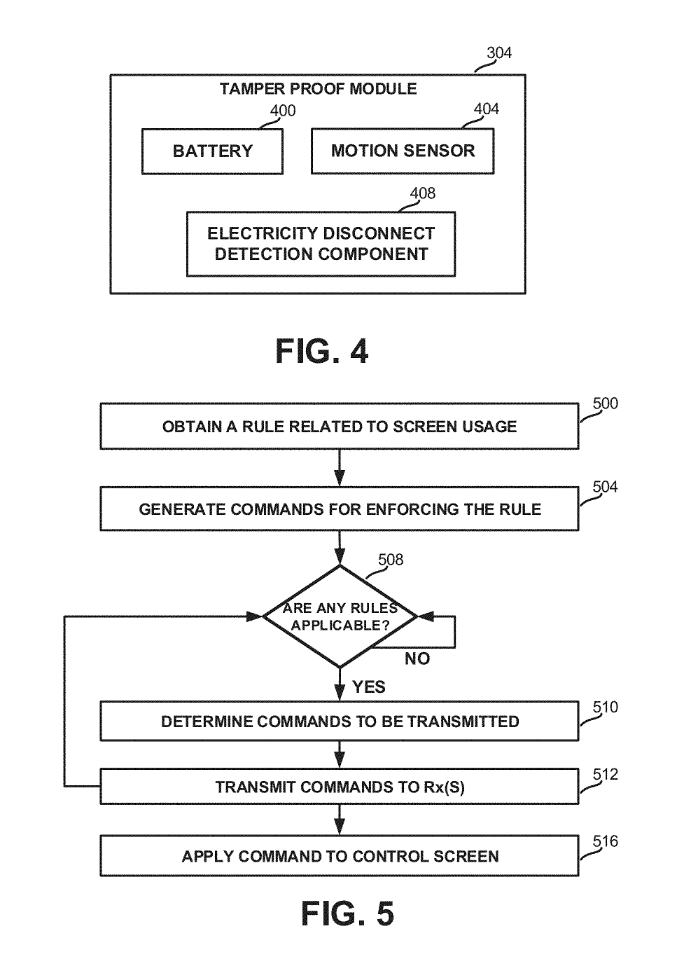

In addition, Tx 310 may comprise a tamper proof module 304 for detecting tamper attempts which may be exercised by users trying to avoid or override the rules, and transmitting the notifications to an external device such as local management module 202, or otherwise notify a supervisor, for example by sending a message to a predetermined phone, e-mail account, or the like. Tamper proof module 304 is detailed in association with FIG. 4 below.

In some embodiments, Rx 106 may also send notifications other than tamper attempts reporting, such as when a user turned the screen off, changed a channel to one of the allowed channels, or the like. In case the user is a child, this may serve for positive rewarding.

Additionally, two-way communication can be held between Rx 106 and Tx 310 using any required protocol, such that Rx 106 provides feedback to Tx 310, upon which Tx 310 can determine how to continue enforcing the rules. In the two-way communication, Tx 310 can transmit to Rx 106 content or commands In the other direction, Rx 106 can use messages in the protocol enabling it to pass content to Tx 310. For example, if Tx 310 enforces a rule related to total usage time, Rx 106 can send notifications whenever the device is on, thus enabling Tx 310 to accumulate the usage time and determine when to apply the rule and send a blocking or shutting command to Rx 106. In another example, if Tx 310 enforces a rule related to Parental Guidance (PG), Rx 106 can capture an image or a sequence of images displayed on screen 104 and transmit them to Rx 106 for verification that the rule is indeed enforced. In this configuration, too, Tx 310 and Rx 106 are on the same network or otherwise communicate in authenticated communication.

Tx 310 can also function as a gateway that link between Rx 106 and components external to network 110, including cloud server 200.

However, Rx 106 can have additional communication capabilities and may communicate directly with rule storage 205 or with another content-providing component. This configuration can also be applicable to multi-screen environments such as waiting rooms, schools, or other environments, in which each screen may be controlled under the same or different rules, and wherein users are not allowed or not supposed to affect the content displayed on screen 104. The configuration can also be applicable to a multiplicity of Tx 310 each controlling one or more Rx 106.

It will be appreciated that in this configuration communication between Tx 310 and cloud server 200 may be encrypted, to avoid overruling of rules set by the supervisors, or displaying content that does not comply with the rules.

This system configuration thus allows a supervisor to monitor, limit, supervise, review, enforce and control the screen usage time and content being consumed by a user at any given time and from any location, as long as Tx 310 is located within local communication distance from Rx 106 to establish successful engagement between Tx 310 and Rx 106, or wherein authenticated communication is available between Tx 310 and Rx 106. Tx 310 of this configuration can be a dedicated device, that may have superior capabilities to those of Tx 110 or 210 in the systems shown in FIGS. 1A and 2 above. Thus Tx 310 can function as a gateway that link between Rx 106 and components external to network 110, including cloud server 200.

This system configuration requires an active Internet connection to allow communication between Tx 310 and cloud server 200. In case Tx 310 is external to the surrounding, Rx 106 can receive commands directly from cloud server 200.

Referring now to FIG. 4, showing a schematic block diagram of tamper proof module 304.

Tx 310 may be a dedicated device, thus it is not expected to be moved, disconnected, sabotaged, or otherwise manipulated. Thus, if it is manipulated, it may be an indication of tampering or a tampering attempt by a user trying to override the limitations imposed by Tx 310.

Tamper proof module 304 may comprise battery 400, such that if Tx 310 is plugged out from the electricity network it can still provide notifications to a supervisor regarding the tamper attempts. Battery 500 may thus serve as a backup battery for Tx 310 and start providing energy if the power supply is stopped for any reason.

Tamper proof module 304 may comprise a motion sensor 404 for example an accelerometer sensing motion in one or more directions, such as an x-y-z accelerometer. Since Tx 310 is not supposed to be moved on a regular basis, if movement is sensed by accelerometer 404, a notification may be sensed. The direction or magnitude may or may not be of particular importance, and thus may or may not be notified to the supervisor.

Tamper proof module 304 may comprise an electricity disconnect detection component 408, such as but not limited to a disconnect detection component, such as Consumer Electronics Control (CEC) applicable for HDMI, which can be used when Rx 106 is connected to the screen via HDMI, for identifying disconnection of the cable or another connection within the HDMI connector between Tx 310 and screen 104.

Thus, Tamper proof module 304 is adapted to identify common modes of tamper attempts, such as disconnecting or moving the device, and notify a supervisor accordingly.

Referring now to FIG. 5, showing a generalized flowchart of a method for controlling a screen in accordance with the disclosure.

At step 500, a user interface component such as user interface 116, global management module 202 may obtain a description of a rule from a supervisor. The description can include the screen or screens the rule relates to, date and time, type of limitation, such as shutting the screen, displaying specific content, displaying content from a specific site, limiting the channels the screen can switch to one or more channels, limiting the amount of time a screen can be used within a timeframe, or the like. The description can further include information such as message text to be displayed, a reminder time prior to applying a rule, or the like.

The types of rules may be in accordance with the type of Tx and Rx used, and their capabilities. Thus, in some embodiments only options relevant to the capabilities of the used equipment may be enabled to a user.

At step 504, one or more commands can be generated upon the rules, for example by command generator 118, or global management module 202. The commands can be generated ahead after the rule is provided, or when the rule becomes applicable. The commands may include displaying a reminder or warning a predetermined time prior to the time a rule becomes applicable, for example 10 minutes before the screen is supposed to be turned off. The commands can further include one or more commands to be transmitted every predetermined period of time when the rule is in effect, for example every 0.1 second and one minute. Executing the command by Rx 106 can repeatedly apply the rule, thus preventing a user from breaking the rule by forcing an action contradicting the rule. The commands may further include displaying a message on the screen, indicating when the current rule will expire. The type, duration or frequency of the commands may depend on predetermined values or on supervisor settings. For example, the frequency of the enforcing commands may be predetermined, while the time of the reminder prior to applying a rule may be set by a supervisor.

At step 508, it may be determined whether any rule is applicable at the present time. Applicability of a rule may also include whether a reminder time prior to the rule has arrived, whether the screen usage has reached a limit within a time frame in case a rule limiting the usage was defined, or disallowed content is being displayed. When such situation is identified, a blocking or turning of command may be transmitted. Determination can be performed, for example, by Tx 110 or 210 in the configurations shown in FIGS. 1A or 2 above, by management tool 402 in the configuration shown in FIG. 3, or the like.

At step 510, one or more commands to be transmitted for applying the rules can be determined when a rule is applicable. A rule may be applicable if the rule is associated with a predetermined hour, or for example, if a limitation is imposed on the total or on specific usage time of the screen, once this time ends. The rule can expire on the next day, if the limitation relates to the same day, or similarly for other time frames.

Enforcing such rule may include the Tx receiving notifications from Rx indicating when the screen is active, and accumulating the time such that it can be compared to the applicable limitation. When such rules are applied, when the allotted time is close to exhaustion. A user may be displayed with one or more messages before this rule takes effect, for example one hour before the time is up, 10 minutes before the time is up, or one minute before the time is up.

At step 512, a command can be transmitted to the Rx, which can then apply it and enforce the rule.

In some embodiments, once a rule becomes applicable, all commands for continuous enforcing of the rule, which may be transmitted at intervals, for example at predetermined intervals, without further checks. In other embodiments, a check may be performed prior to every transmission throughout the applicability period of the rule.

Determining the commands can repeat for further rules, which can relate to further Rxs. If a Tx is equipped with capabilities of simultaneous processing, multiple such checks may be performed concurrently.

In some embodiments, a time table may be prepared or updated whenever a rule is added, deleted or changed, indicating for each point in time whether and which rule becomes applicable, and for which Tx. In such embodiments, it may not be required to traverse over all rules, but rather to set a timer to the next point in time where a rule becomes applicable.

The commands, if not generated by the Tx can be provided to the Tx, for example by a management module.

At step 516, the Rx may apply the commands transmitted to the Rx on stage 512, and thus control the screen in accordance with the at least one rule. Applying the commands may include sending notifications to the Tx, such that content is being displayed on the screen, or sending content, such as the content being displayed on the screen. The notifications or content can be used by the Tx for determining whether a time limit or a content limit rule is to be enforced.

It will be appreciated that the configurations above are exemplary only, and that further configurations may be designed without deviating from the scope of the disclosure. Each of the steps of receiving a rule description from a user, generating commands in accordance with the rule, and transmitting the commands to an Rx that has control over a screen can be performed by a unit in the network of the Rx or an external one.

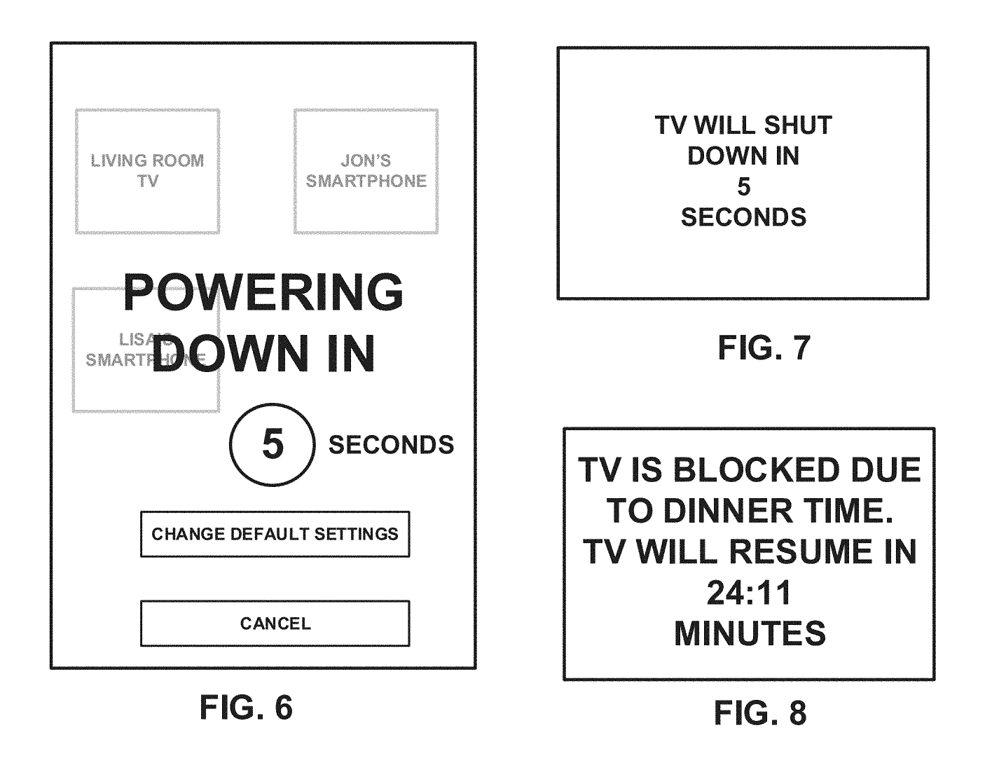

In some embodiments, the transmitter or the management module may enable a supervisor to block or shut down any one or more of the associated screens immediately, or with a warning of a few minutes or seconds. A popup window may allow a supervisor to cancel the shutdown command, or customize the time frame and messaging notifications. FIG. 6 shows a schematic screen shot of a user interface of a management device displayed when shutting down one or more screens.

FIG. 7 shows the corresponding message that can be displayed on a screen such as a TV during shutdown, and FIG. 8 shows a message that can be displayed when the screen is blocked in accordance with a rule. The displayed image may be rendered by and transmitted from a corresponding Tx. The notifications time and content can be set by the supervisor to be in a form of an image, text, video, sound, or any combination thereof. The message is edited by any authorized “supervisor” via the management tool.

It will be appreciated that a system in accordance with the disclosure can also be a part of an Internet of Things (IoT) platform, wherein a dashboard such as user interface of global management module 202 controls and manages the other IoT devices around one or more screens 104 or other devices.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), local generated hotspot, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for managing usage over a screen comprising:
a transmitter configured to transmit a multiplicity of commands related to managing usage of a screen in accordance with at least one rule, the multiplicity of commands sent at intervals during an applicability time period of the at least one rule; and
a receiver operatively connected to the screen, the receiver configured to receive the commands from the transmitter and apply the commands to the screen, thereby managing usage of the screen for the applicability time period of the at least one rule,
wherein the transmitter and the receiver communicate with each other using authenticated communication.

2. The system of claim 1, wherein the transmitter comprises:
a user interface for receiving a description of the at least one rule from a supervisor;
a command generator for generating the multiplicity of commands upon the at least one rule;
a command enforcer for determining a command from the multiplicity of commands to be transmitted to the receiver; and
a communication module for transmitting the command to the receiver.

3. The system of claim 1, wherein the receiver comprises:
a communication module for receiving a command from the receiver; and
a command application module for applying the command to the screen, thereby limiting operation of the screen in accordance with the at least one rule.

4. The system of claim 1, further comprising:
a global management module for receiving a description of the at least one rule; and
a rule storage accessible via the Internet,
wherein the transmitter further comprises a rule or command communicator for receiving rules or commands from the rule storage, and
wherein a description via the global management module is stored on the rule storage and is provided to the transmitter.

5. The system of claim 4, further comprising at least one second transmitter.

6. The system of claim 4, wherein the transmitter comprises a tamper proof module for identifying tamper or tamper attempt to the transmitter, and wherein the transmitter is configured to notify a supervisor about the tamper or tamper attempts.

7. The system of claim 6, wherein the tamper proof module comprises a battery.

8. The system of claim 6, wherein the tamper proof module comprises a motion sensor.

9. The system of claim 6, wherein the tamper proof module comprises an electricity disconnect detection component.

10. The system of claim 1, wherein the at least one rule relates to turning the screen off at predetermined time, turning the screen on at predetermined time, blocking the screen, and showing information on the screen.

11. The system of claim 1, wherein the at least one rule relates to limiting content displayed on the screen.

12. The system of claim 1, further comprising at least one second receiver, wherein the transmitter is also configured to transmit a second multiplicity of commands to the at least one a second receiver.

13. The system of claim 1, wherein the receiver transmits to the transmitter notifications related to usage of the screen or to compliance of the user with the at least one rule.

14. A method of controlling usage over a screen, comprising:
transmitting a multiplicity of commands related to limiting usage of a screen in accordance with at least one rule, the multiplicity of commands sent by a transmitter to a receiver operatively connected to the screen at time intervals during an applicability time period of the at least one rule, wherein the receiver is configured to apply the commands to the screen,
wherein the transmitter and the receiver communicate in an authenticated manner.

15. The method of claim 14, further comprising:
receiving a description of the at least one rule from a supervisor;
generating the multiplicity of commands upon the at least one rule; and
determining a command from the multiplicity of commands to be transmitted to the receiver.

16. The method of claim 14, further comprising:
storing the at least one rule or the multiplicity of commands in a rule storage accessible via the Internet, and
transmitting the rule or the multiplicity of commands to the transmitter

17. The method of claim 14, wherein the at least one rule relates to turning the screen off at predetermined time, turning the screen on at predetermined time, blocking the screen, and showing information on the screen or to limiting content displayed on the screen.

18. The method of claim 14, further comprising receiving a notification related to tampering or tampering attempt of the transmitter.

19. A system for controlling usage over a screen comprising:
a transmitter configured to transmit a multiplicity of commands related to limiting usage of a screen in accordance with at least one rule, the multiplicity of commands sent at intervals during an applicability time period of the at least one rule,
the transmitter comprising a tamper proof module for identifying tampering or tampering attempts to the transmitter, the tamper proof module comprising a battery; and
a receiver operatively connected to the screen, the receiver configured to receive the commands from the transmitter and apply the commands to the screen, thereby limiting usage of the screen for the applicability time period of the at least one rule,
wherein the wherein the transmitter and the receiver communicate in an authenticated manner
